(19) United States
(12) Patent Application Publication
(10) Pub. No.: US 2019/0379626 A1
(43) Pub. Date: Dec. 12, 2019

(54) TRANSFER OF DATA BASED ON MOVEMENT OF A USER

(71) Applicant: INTERNATIONAL BUSINESS MACHINES CORPORATION, Armonk, NY (US)

(72) Inventors: Yuk L. Chan, Rochester, NY (US); Heidi Lagares-Greenblatt, Jefferson Hills, PA (US); Deepti M. Naphade, Cupertino, CA (US)

(21) Appl. No.: 16/001,116

(22) Filed: Jun. 6, 2018

(51) Int. Cl. H04L 12/58; G06F 3/147; G06F 3/01; H04L 29/08

(52) U.S. Cl. CPC H04L 51/24; G06F 3/147; H04L 67/306; H04L 67/18; G06F 3/011

(57) ABSTRACT

Transferring data between user devices based on a movement of a user is provided. Aspects include monitoring user interaction with a plurality of user devices and detecting movement of the user with sensors of one or more of the plurality of user devices. Aspects also include obtaining user preferences from a user profile and identifying one or more data items to be transferred from a first user device of the plurality of user devices to a second user device of the plurality of user devices based on the user interaction, the detected movement of the user and the user preferences. Aspects further include transferring the one or more data items to be transferred from the first user device of the plurality of user devices to the second user device of the plurality of user devices.

### BACKGROUND

The invention relates generally to transferring data between user devices and, more specifically, to transferring data between user devices based on a detected movement of a user.

In today's busy world, people are constantly on the move and are commonly multitasking to accomplish multiple tasks with a variety of electronic devices. As a result, there are often actions or tasks that get forgotten that are left incomplete. For example, it is common for people to ignore certain messages because they are busy at the time they receive the message. People often will user forget they ever got those messages and the messages are unintentionally not replied to.

### SUMMARY

According to an embodiment, a system for transferring data between user devices based on a movement of the user is provided. The system includes a plurality of user devices that each have a memory having computer readable computer instructions, and a processor for executing the computer readable instructions. The computer readable instructions include monitoring user interaction with a plurality of user devices and detecting movement of the user with sensors of one or more of the plurality of user devices. The computer readable instructions also include instructions for obtaining user preferences from a user profile and identifying one or more data items to be transferred from a first user device of the plurality of user devices to a second user device of the plurality of user devices based on the user interaction, the detected movement of the user and the user preferences. The computer readable instructions further include instructions for transferring the one or more data items to be transferred from the first user device of the plurality of user devices to the second user device of the plurality of user devices.

According to another embodiment, a method for transferring data between user devices based on a movement of the user is provided. The method includes monitoring user interaction with a plurality of user devices and detecting movement of the user with sensors of one or more of the plurality of user devices. The method also includes obtaining user preferences from a user profile and identifying one or more data items to be transferred from a first user device of the plurality of user devices to a second user device of the plurality of user devices based on the user interaction, the detected movement of the user and the user preferences. The method further includes transferring the one or more data items to be transferred from the first user device of the plurality of user devices to the second user device of the plurality of user devices.

According to a further embodiment, a computer program product is provided. The computer program product includes a computer readable storage medium having program instructions embodied therewith. The program instructions are executable by a computer processor to cause the computer processor to perform a method. The method includes monitoring user interaction with a plurality of user devices and detecting movement of the user with sensors of one or more of the plurality of user devices. The method also includes obtaining user preferences from a user profile and identifying one or more data items to be transferred from a first user device of the plurality of user devices to a second user device of the plurality of user devices based on the user interaction, the detected movement of the user and the user preferences. The method further includes transferring the one or more data items to be transferred from the first user device of the plurality of user devices to the second user device of the plurality of user devices.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, in which:

FIG. 1 depicts a cloud computing environment according to one or more embodiments of the present invention;

FIG. 2 depicts abstraction model layers according to one or more embodiments of the present invention;

FIG. 3 depicts an exemplary computer system capable of implementing one or more embodiments of the present invention;

FIG. 4 depicts a system upon which transferring data between user devices based on a movement of a user may be implemented according to an embodiment of the invention; and

FIG. 5 depicts a flow diagram of a method for transferring data between user devices based on a movement of a user according to an embodiment of the invention.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

Deployment Models are as follows:

Private cloud: the cloud infrastructure is operated solely for an organization. It may be managed by the organization or a third party and may exist, on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist, on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

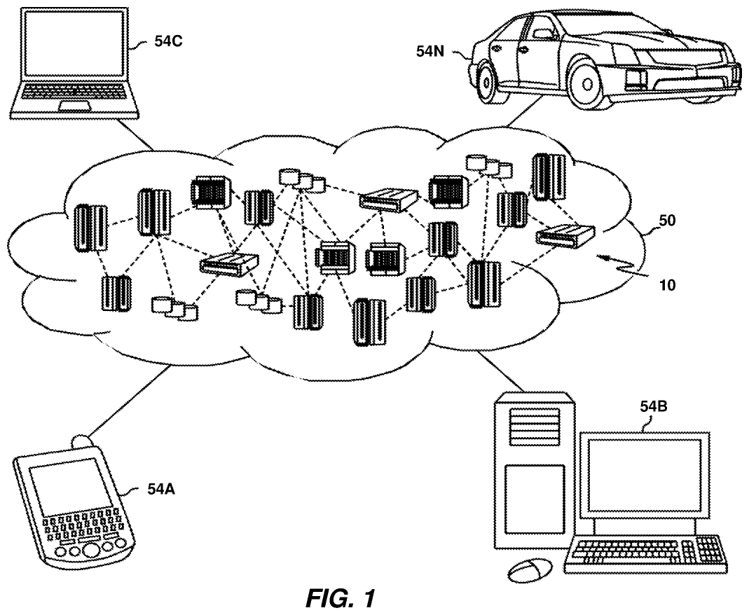

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

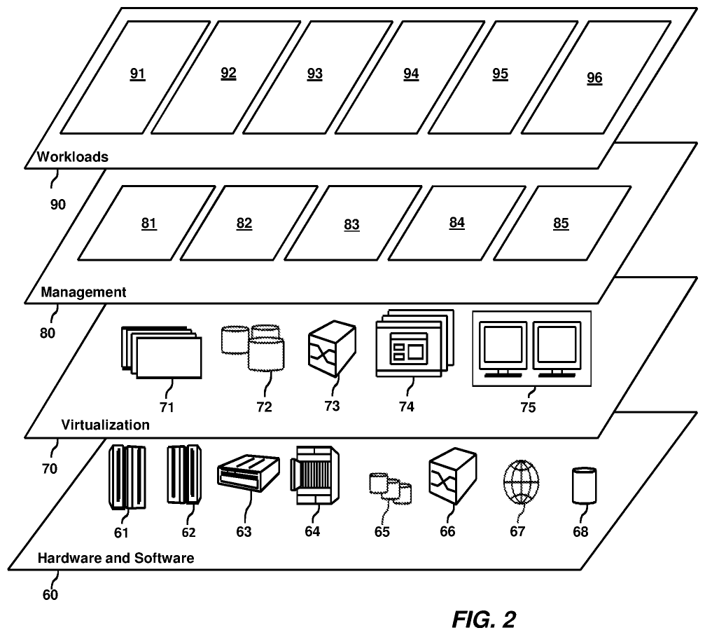

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and transferring data between user devices based on a movement of a user 96.

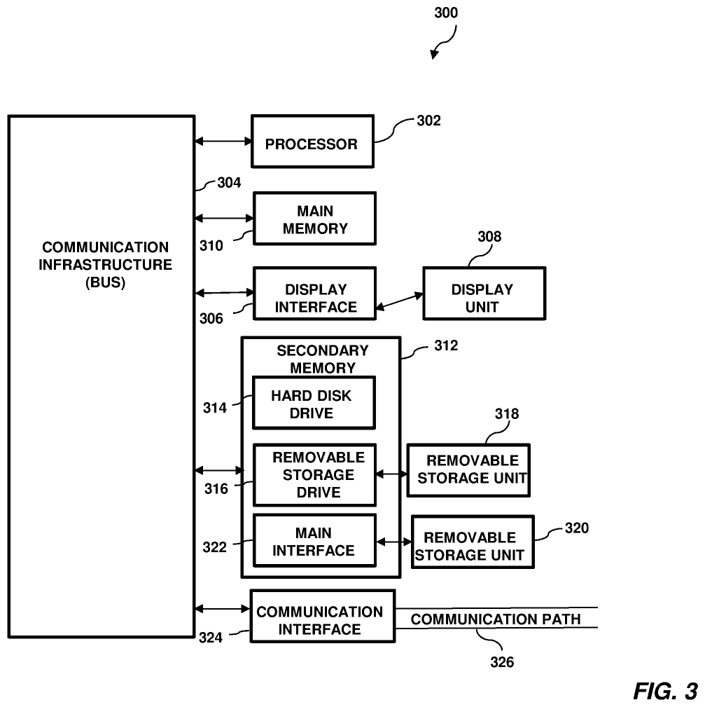

Turning now to a more detailed description of aspects of the present invention, FIG. 3 illustrates a high-level block diagram showing an example of a computer-based system 300 useful for implementing one or more embodiments of the invention. Although one exemplary computer system 300 is shown, computer system 300 includes a communication path 326, which connects computer system 300 to additional systems and may include one or more wide area networks (WANs) and/or local area networks (LANs) such as the internet, intranet(s), and/or wireless communication network(s). Computer system 300 and additional systems are in communication via communication path 326, (e.g., to communicate data between them).

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc. which is read by and written to by a removable storage drive 316. As will be appreciated, removable storage unit 318 includes a computer readable medium having stored therein computer software and/or data.

In some alternative embodiments of the invention, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etc. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310, and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

In exemplary embodiments, methods for transferring data amongst user devices based on the movements of a user are provided. For example, if a data stream is being displayed by a first device and the user is detected moving away from the first device to a second device, the first device can be configured to transfer the data stream to the second device. In another example, if an incoming message to a first user device has not been read by the user, and is detected moving towards a second device, the first device will transfer the message to the second device.

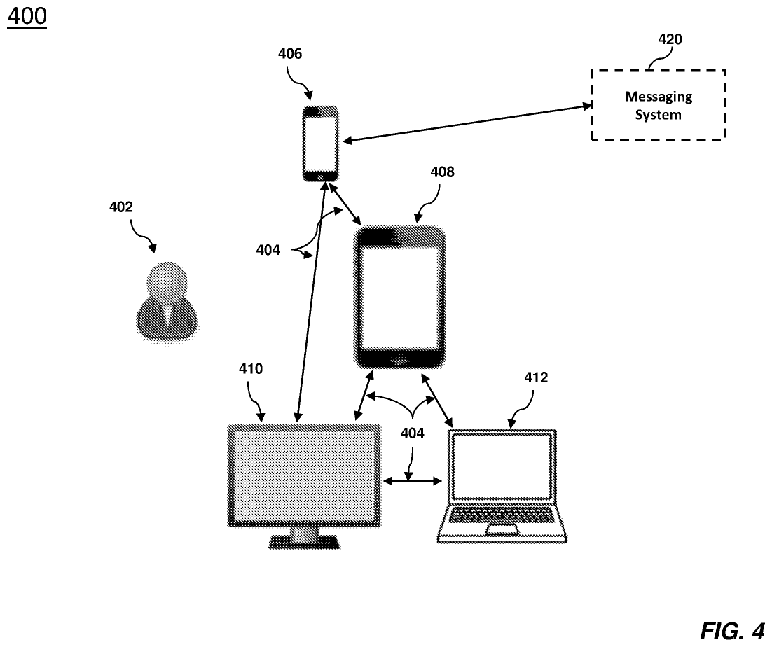

Turning now to FIG. 4, a system 400 upon which transferring data between user devices based on a movement of a user may be implemented will now be described. The system 400 shown in FIG. 4 includes a user 402 and a plurality of user devices that include, but are not limited to a smartphone 406, a tablet 408, a television 410, and a laptop 412. Each of the plurality of user devices are configured to communicate directly with the other user devices in the vicinity of one another via a communications link 404. Each of the plurality of user devices include sensors, such a video camera that are configured to monitor the movements of the user. The movement of the user can include the movement of the user from one location to another and/or the movement of the user's head and/or eyes.

As illustrated, the system 400 can also include a messaging system 420 such as an email or instant messaging system. In one embodiment, the messaging system 420 sends a message to a smartphone 406 of the user 402. The user 402 may look at the message and draft a reply on the smartphone 406 but during drafting the reply the user receives a call. By the time the user has completed their call, they may have forgotten about the message and their in progress reply. The smartphone 406 detects the movements of the user and determines that the user is now at their desk and is using laptop 412. Based on this detected movement, the smartphone 406 can transfer the draft reply message to the laptop 412 for the user to complete and send. Alternatively, the smartphone 406 may transfer a notification to the laptop 412 that reminds the user to complete their reply on the smartphone 406. The determination of what information to transfer from the smartphone 406 to the laptop 412 and what data to present to the user via the laptop 412 is determined based upon the detected movement and upon one or more user preferences that are stored on one or more of the plurality of user devices.

In one example, the user 402 is sharing the screen of their laptop 412 during a presentation. The user has a calendar “pop-up” to remind them about a Doctor's appointment in 60 minutes. Since the user is sharing their screen, the message does not show on the screen and instead, it goes to the background of the laptop 412. The user 402 finishes the presentation and instead of closing their screen, they close their laptop 412. In this case, the laptop 412 will recognize that the user never touched/read the “pop-up” message. Accordingly, the laptop will detect the movement of the user 402 and will transfer the data regarding the “pop-up” message to another user device based on the detected movement. For example, if after the laptop 412 was closed the user turned on their television 410, the television would receive the data regarding the “pop-up” message and display it to the user 402.

In exemplary embodiments, the plurality of user devices are configured to communicate directly with one another and to determine which of the plurality of user devices is being actively used by the user. The plurality of user devices can also determine the location of the user in relation to each of the plurality of user devices by using sensors within the user devices. In one embodiment, this information can also be stored in a cloud based system that is accessible to each of the plurality of user devices.

In exemplary embodiments, the movements of the user are monitored by one or more of the plurality of user devices. For example, the user devices can include location sensors and accelerometers that are used to detect if the user device, and therefore the user, is moving from one location to another. In another example, the user devices can include cameras that can detect eye/head movements of the user. In exemplary embodiments, the user devices can determine if a user is in a reading position, if the user is running, etc.

In one embodiment, if a user is taking an action which is still in progress, the device that they are using can be configured to transfer the data related to the action (or action messages) to the other devices based on the movement of the user. In addition, if a message or application on a first user device needs the user's action, but none has taken, the first user device can transfer data to a second user device that is being actively used by the user. For example, a user is downloading a program to their laptop and they start getting certificates of approval, which the user has to click in order to continue with the download or installation. The laptop will transfer data regarding the certificates to another device, which is likely being used or in the vicinity of the user, based on the detected movements of the user.

In some embodiment, an application maybe executed on both devices (the starting device and the new devices which are based on the movement), in this case, the starting device can transfer the data packets and the user can take the action in the new device automatically (or by a quick interrupt message if the user choose to have a quick interrupt). However, in cases in which the new device cannot operate the application on the starting device that needs attention, the second device can be configured to provide a notification to the user to take the action on the starting device. Alternatively, the devices can be connected to the cloud and the applications and actions can be executed by the user in the cloud.

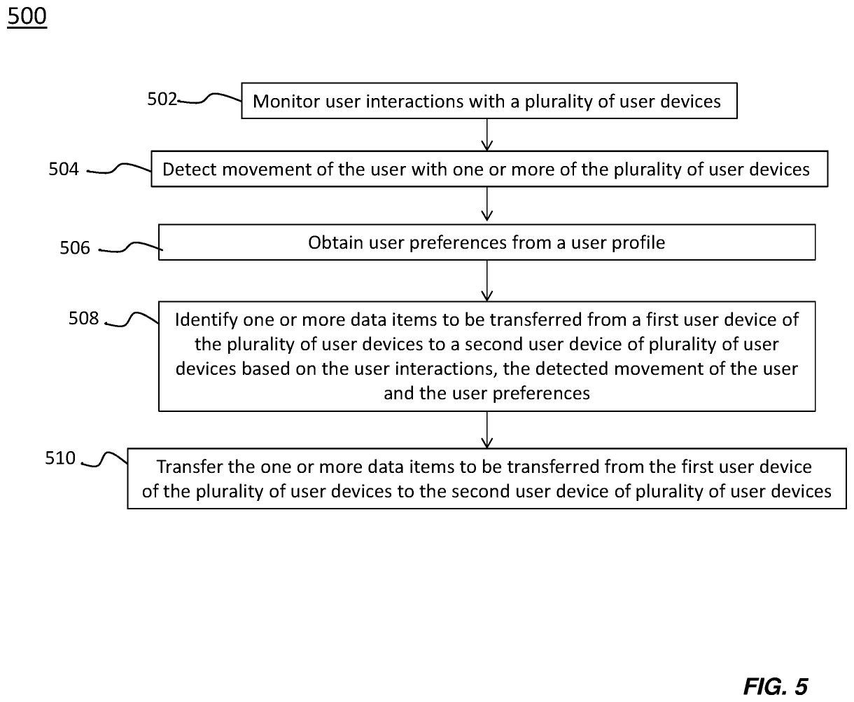

Turning now to FIG. 5, a flow diagram of a method 500 for transferring data between user devices based on a movement of a user in accordance with an embodiment is shown. As illustrated, the method 500 includes monitoring user interaction with a plurality of user devices, as shown at block 502. In exemplary embodiments, the user interactions include the manner in which the user is using the device. For example, if the user device is a smartphone, the user interactions can include determining that the user is watching a video on the device, making a call on the device, sending an email or text, or the like. Next, as shown at block 504, the method 500 includes detecting a movement of the user with sensors of one or more of the plurality of user devices. The movement of the user can include the user moving from one location to another or it can be the user changing their focus to, or from, a device. The one or more sensors can include cameras, accelerometers, gyroscopes, GPS sensors, or the like. In one embodiment, a detected user movement may be detecting that a user has gotten up from their work computer and left their office.

Next, as shown at block 506, the method 500 includes obtaining user preferences from a user profile. The user profile may be stored on one or more of the plurality of user devices or in a cloud based storage system, such as the one shown in FIGS. 1 and 2. The user preferences are stored preferences that control when each of the plurality of user devices will transfer data amongst one another based on the type of data and the detected user movements. The user preferences are specified by the user and can be modified by the user at any time. The method 508 also includes identifying one or more data items to be transferred from a first user device of the plurality of user devices to a second user device of the plurality of user devices based on the user interactions, the detected movement of the user and the user preferences. Nest, the method 500 includes transferring the one or more data items to be transferred from the first user device of the plurality of user devices to the second user device of the plurality of user devices, as shown at block 510. In exemplary embodiments, the one or more data items are transferred directly from the first user device to the second user device in a point to manner. In addition, the one or more data items can be encrypted during the transfer process. In one embodiment, the one or more data items include an unread message for the user received by the first user device, instructions for the second user device to obtain an unread message for the user received by the first user device.

In exemplary embodiments, the method can also include presenting a notification to the user on the second user device based on the one or more data items. For example, if the one or more data items include an email that the user drafted a using the first user device but failed to send, the second user device may provide a notification to the user to remind them to send the drafted email. In this example, the notification can include the option for the user to elect to instruct the first user device to send the email via the second user device. In exemplary embodiments, a content of the notification is determined based on a type of the second user device and upon the user preferences. For example, if the second user device is a television screen or another type of display that can be seen by others, the user may prefer that the notification only include very high level information and not details of the transferred data items. However, if the second user device is a wearable device that is only likely to be seen by the user the user may prefer the details of the transferred data items be displayed.

In exemplary embodiments, the method can also include transmitting an indication from the second user device to the first user device that the user read the notification. The indication that the user read the notification can include a confidence level that the user read the notification and data used to calculate the confidence level. For example, the second user device can determine that it is likely that the user read the notification based on determining that the user's eyes were focused on a display of the user device for more than a threshold amount of time. Likewise, the second user device can determine that it is highly likely that the user read the notification based on receiving a user input to mark the notification as read or by determining that the user took an action based on the notification. For example, if the notification is a reminder to call a specific individual and the second user device determines that the user called that individual, the second user device can mark that notification as read.

In exemplary embodiments, the method can also include deleting the one or more data items from the second user device based on detecting another movement of the user. For example, if the user leaves his office and his work computer transfers one or more data items to the infotainment system of his vehicle, the vehicle may be configured to delete these data items once it detects that the user leaves the vehicle. In addition, it may be configured to transmit the one or more data items to a third user device, such as the user's home computer or tablet prior to deleting the data items.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for transferring data between user devices based on a movement of a user, comprising:
a plurality of user devices that each comprise a memory having computer readable instructions and a processor for executing the computer readable instructions, the computer readable instructions including instructions for:
monitoring user interaction with a plurality of user devices;
detecting movement of the user with sensors of one or more of the plurality of user devices;
obtaining user preferences from a user profile;
identifying one or more data items to be transferred from a first user device of the plurality of user devices to a second user device of the plurality of user devices based on the user interaction, the detected movement of the user and the user preferences; and
transferring the one or more data items to be transferred from the first user device of the plurality of user devices to the second user device of the plurality of user devices.

2. The system of claim 1, wherein the computer readable instructions further include instructions for presenting a notification to the user on the second user device based on the one or more data items.

3. The system of claim 2, wherein a content of the notification is determined based on a type of the second user device and upon the user preferences.

4. The system of claim 2, wherein the computer readable instructions further include instructions for transmitting an indication from the second user device to the first user device that the user read the notification.

5. The system of claim 4, wherein the indication that the user read the notification includes a confidence level that the user read the notification and data used to calculate the confidence level.

6. The system of claim 1, wherein the computer readable instructions further include instructions for deleting the one or more data items from the second user device based on detecting another movement of the user.

7. The system of claim 1, wherein the one or more data items include an unread message for the user received by the first user device.

8. The system of claim 1, wherein the one or more data items include instructions for the second user device to obtain an unread message for the user received by the first user device.

9. A method for transferring data between user devices based on a movement of a user, comprising:
monitoring user interaction with a plurality of user devices;
detecting movement of the user with sensors of one or more of the plurality of user devices;
obtaining user preferences from a user profile;
identifying one or more data items to be transferred from a first user device of the plurality of user devices to a second user device of the plurality of user devices based on the user interaction, the detected movement of the user and the user preferences; and
transferring the one or more data items to be transferred from the first user device of the plurality of user devices to the second user device of the plurality of user devices.

10. The method of claim 9, further comprising presenting a notification to the user on the second user device based on the one or more data items.

11. The method of claim 10, wherein a content of the notification is determined based on a type of the second user device and upon the user preferences.

12. The method of claim 10, further comprising transmitting an indication from the second user device to the first user device that the user read the notification.

13. The method of claim 12, wherein the indication that the user read the notification includes a confidence level that the user read the notification and data used to calculate the confidence level.

14. The method of claim 9, further comprising deleting the one or more data items from the second user device based on detecting another movement of the user.

15. The method of claim 9, wherein the one or more data items include an unread message for the user received by the first user device.

16. The method of claim 9, wherein the one or more data items include instructions for the second user device to obtain an unread message for the user received by the first user device.

17. A computer program product comprising a computer readable storage medium having program instructions embodied therewith the program instructions executable by a computer processor to cause the computer processor to perform a method, comprising:
monitoring user interaction with a plurality of user devices;
detecting movement of a user with sensors of one or more of the plurality of user devices;
obtaining user preferences from a user profile;
identifying one or more data items to be transferred from a first user device of the plurality of user devices to a second user device of the plurality of user devices based on the user interaction, the detected movement of the user and the user preferences; and
transferring the one or more data items to be transferred from the first user device of the plurality of user devices to the second user device of the plurality of user devices.

18. The computer program product of claim 17, wherein the method further comprises presenting a notification to the user on the second user device based on the one or more data items.

19. The computer program product of claim 18, wherein a content of the notification is determined based on a type of the second user device and upon the user preferences.

20. The computer program product of claim 18, wherein the method further comprises transmitting an indication from the second user device to the first user device that the user read the notification.
